(19) United States
(12) Patent Application Publication
(10) Pub. No.: US 2025/0112303 A1
(43) Pub. Date: Apr. 3, 2025

(54) MATERIALS AND METHODS FOR IMPROVING AVERSIVE-AGENT COATING ADHESION TO BATTERY CASING

(71) Applicant: Energizer Brands, LLC, St. Louis, MO (US)

(72) Inventors: Jingdong Guo, Westlake, OH (US); Ziqiang Wang, Shanghai (CN)

(21) Appl. No.: 18/593,561

(22) Filed: Mar. 1, 2024

Related U.S. Application Data
(60) Provisional application No. 63/586,879, filed on Sep. 29, 2023.

(51) Int. Cl. H01M 50/124; C08K 5/20; C08K 5/42; C08K 5/544; C09D 5/00; C09D 7/41; C09D 7/63; C09D 129/04; H01M 10/04; H01M 50/109; H01M 50/559

(52) U.S. Cl. CPC H01M 50/1245; C09D 5/00; C09D 7/41; C09D 7/63; C09D 129/04; H01M 10/0427; H01M 50/109; H01M 50/559; C08K 5/20; C08K 5/42; C08K 5/544

(57) ABSTRACT

Provided are electrochemical cells with at least a portion of the exterior surface coated in an aversive coating to deter children from eating the electrochemical cell. Described are compositions and methods for improving the adhesion of the aversive coating to the surface of the electrochemical cell.

### CROSS REFERENCE TO RELATED APPLICATIONS

This application claims the benefit of U.S. Provisional Application No. 63/586,879, filed Sep. 29, 2023, which is incorporated herein by reference in its entirety.

This application also incorporates by reference U.S. Provisional Application Nos. 63/508,777, filed Jun. 16, 2023; 63/508,745, filed Jun. 16, 2023; and 63/508,764, filed Jun. 16, 2023.

### FIELD

The present disclosure relates, generally, to coin or button type electrochemical cells.

### BACKGROUND

Coin cells or coin cell batteries, such as those described in International Patent Publication No. PCT/US2013/021430, filed Jan. 14, 2013, the contents of which are incorporated herein by reference in their entirety, are small, disc-shaped batteries commonly used in a wide range of electronic devices, such as hearing aids, cochlear implant processors, calculators, remote controls, and wristwatches. These cells and batteries are often referred to as button cells due to their shape and size.

Accidental ingestion of coin cells by children can lead to serious injury and even death, in part due to an electrical current from the battery generating hydroxide (high pH) on the negative side through an electrolysis reaction that occurs when the battery is in contact with bodily fluids, such as tissue fluids, mucus, esophageal lining fluids, stomach fluids, or the like. The hydroxide formed causes alkaline burns and perforations of the esophagus. Serious injuries can occur in as little as two hours.

To address this issue, many manufacturers have implemented anti-swallow features. For example, anti-swallow features encompass a bitter-tasting coating on the surface of the battery that deters children from putting the battery in their mouths. However, if swallowed, a coin cell or button cell coated with a bitterant will still cause an electrolysis reaction in the esophagus or stomach and cause severe injury. Therefore, inclusion of a signal to parents or other care-givers that a battery may have been ingested may be helpful. Such signal can be achieved by use of a colorant to stain the mouth, hands, or other areas wetted by body fluids like saliva that have been in contact with a lithium coin cell.

Certain of these coatings may be difficult to adhere to an external surface of a battery, and therefore portions or the entirety of the coating may wear off during the manufacturing process, transportation, or handling of the battery, thereby mitigating any benefits from these coatings. Accordingly, a need exists for materials and methods for improving adhesion between coatings containing bitterants and/or colorants and the external surface of coin cell or button cell batteries.

### BRIEF SUMMARY

Various embodiments provide electrochemical cells with at least a portion of the exterior surface coated in an aversive coating to deter children from eating the electrochemical cells. The aversive coating comprises an aversive agent composition and a water-soluble polymer. The aversive agent composition comprises at least one aversive taste agent and optionally a colorant. In some embodiments, the aversive taste agent is denatonium benzoate (DNB), capsaicin, allyl isothiocyanate, or piperine. In some embodiments, the aversive taste agent is DNB. The exterior of the electrochemical cell is prepared for adhesion with an aversive coating by performing a mechanical process or applying a composition to the exterior of the electrochemical cell to form a prepared exterior portion. The composition applied to the exterior of the cell may be a primer or a surface treatment to facilitate adhesion of the aversive coating to the electrochemical cell.

In some embodiments, the water-soluble polymer is selected from: polyvinyl alcohol (PVA), polyacrylic acid (PAA), polyacrylamide, or polyethylene glycol (PEG). In some embodiments, the water-soluble polymer is PVA. In some embodiments, the PVA has a molecular weight of about 10,000 to about 150,000. In some embodiments, the PVA is about 80% to about 95% hydrolyzed. In some embodiments, the PVA is has a molecular weight of about 75,000 and is about 88% hydrolyzed.

In some embodiments, the aversive agent composition further comprises a colorant. In some embodiments, the colorant comprises: FD&C Blue No. 1, FD&C Blue No. 2, FD&C Green No. 3, FD&C Red No. 3, FD&C Red No. 40, FD&C Yellow No. 5, or FD&C Yellow No. 6. In some embodiments, the colorant is FD&C Blue No. 1.

In some embodiments, the composition applied to the exterior of the electrochemical cell is a primer, wherein the primer comprises the water-soluble polymer. In some embodiments, the composition applied to the exterior of the electrochemical cell is a surface treatment composition. In some embodiments, the composition applied to the exterior of the electrochemical cell comprises an adhesion promoter. In some embodiments, the adhesion promoter is Lubrizol 2063, Lubrizol 2062, DowSil Z-6137, DowSil 3-6121, or PP-6. In some embodiments, the composition applied to the exterior of the electrochemical cell comprises a surfactant. In some embodiments, the surfactant is sodium dodecyl sulfate (SDS).

In some embodiments, the primer further comprises the aversive taste agent. The primer has a thickness of less than 1 μm. In some embodiments, the primer has a dry-weight composition comprising at least 50 wt % of a water-soluble polymer. In some embodiments, the primer comprises PVA or PAA. In some embodiments, the primer further comprises up to 10 wt % of an aversive taste agent, such as DNB. In some embodiments, the primer further comprises up to 50 wt % of a surfactant or an adhesion promoter.

In some embodiments, the electrochemical cells are coin cells or button cells. In some embodiments, greater than 50% by area of the exterior surface of the positive and/or negative terminal is coated by the aversive coating. In some embodiments, the part of the exterior of the terminal coated in the aversive coating has a shape that comprises one or more of: a stripe, a circle, a ring, an arc, an oval, a square, rectangle, a diamond, a triangle, half-circle or a half-moon. In some embodiments, the aversive coating is applied as a plurality of dots inside of the arc shape, the ring shape, the half-circle shape or the half-moon shape. In some embodiments, the aversive coating is applied as a plurality of dots inside of the arc shape and the arc comprises three sub-arcs, each sub-arc comprising a plurality of dots. In some embodiments, the electrochemical cell is packaged in child-resistant packaging.

Various embodiments provide methods of making electrochemical cells coated in the aversive coatings. The methods comprise preparing a primer solution or surface treatment solution, applying the primer solution or the surface treatment solution to at least a part of the exterior of the electrochemical cell, drying the primer or the surface treatment solution onto the exterior of the electrochemical cell, preparing a coating solution comprising an aversive agent composition and a water-soluble polymer, applying the coating solution to the at least part of the exterior of the electrochemical cell, and drying the coating solution onto the exterior of the electrochemical cell.

In some embodiments, the primer solution comprises 0.01 wt % to 0.5 wt % of the water-soluble polymer dissolved in one or more solvents. In some embodiments, the primer solution further comprises 0.001 wt % to 0.5 wt % of an adhesion promoter in the one or more solvents. In some embodiments, the primer solution further comprises dissolving 0.001 wt % to 0.5 wt % of a surfactant in the one or more solvents. In some embodiments, the primer solution further comprises dissolving 0.001 wt % to 0.02 wt % of the aversive taste agent in the one or more solvents.

The surface treatment solution comprises an adhesion promoter, a surfactant, or an acid dissolved in one or more solvents. In some embodiments, the surface treatment solution comprises 0.01 wt % to 5 wt % of an adhesion promoter in the one or more solvents. In some embodiments, the surface treatment solution comprises dissolving 0.01 wt % to 0.5 wt % of a surfactant in the one or more solvents. In some embodiments, the surface treatment solution is an aqueous solution comprising nitric acid, sulfuric acid, hydrochloric acid, or phosphoric acid. In some embodiments, the surface treatment solution has a concentration of about 1 N of the acid.

In some embodiments, the method of making the electrochemical cell further comprises cleaning the exterior surface of the electrochemical cell before applying the coating solution.

In some embodiments, the exterior of the electrochemical cell is prepared for adhesion performing a mechanical process on the exterior of the electrochemical cell. In some embodiments, the mechanical process is sandblasting, abrasion with sandpaper, tumbling, or milling.

### BRIEF DESCRIPTION OF THE DRAWINGS

Reference will now be made to the accompanying drawings, which are not necessarily drawn to scale. The accompanying appendices, drawings, figures, images, etc. illustrate various example, non-limiting, inventive aspects, embodiments, and features (“e.g.,” or “example(s)”) in accordance with the present disclosure:

FIG. 1 is a schematic of a coin cell, according to an embodiment, submersed in a saliva solution.

FIG. 2 is a perspective and cross-sectional view of an electrochemical coin cell, according to an embodiment.

FIG. 3 is a two-dimensional cross-sectional view of the electrochemical coin cell as illustrated in FIG. 2.

FIG. 4 is a schematic of a process for manufacturing electrochemical cells coated in aversive coatings.

FIGS. 5A-5D illustrate example coating configurations according to various embodiments.

FIG. 6A illustrates the results of adhesion testing coatings of a control cell.

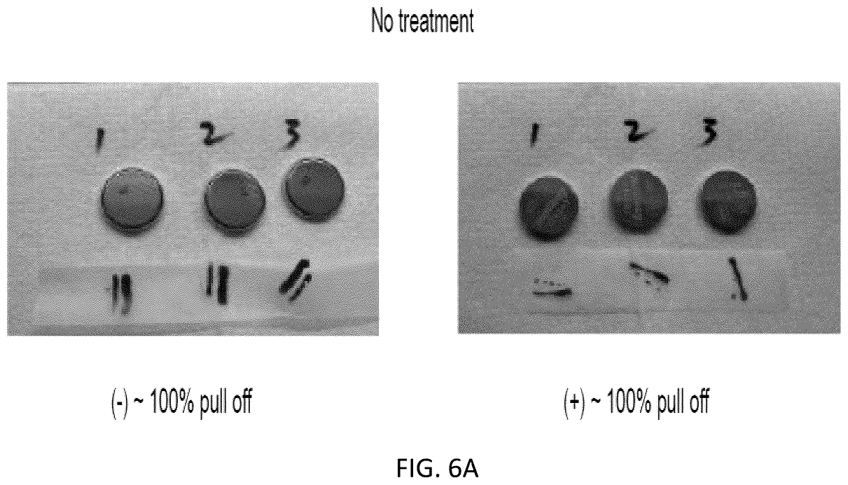

FIGS. 6B-6C illustrates the results of adhesion testing coatings applied to a pre-treated cell according to certain embodiments.

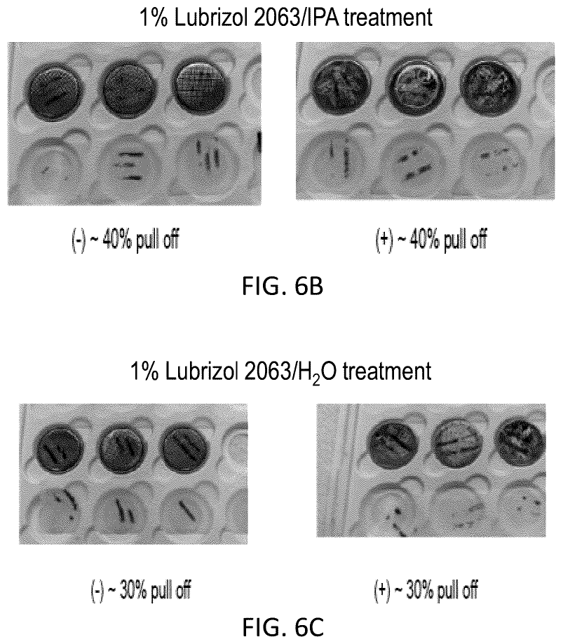

FIGS. 7A-7B illustrates the results of adhesion testing coatings applied to a cell having a primer according to certain embodiments.

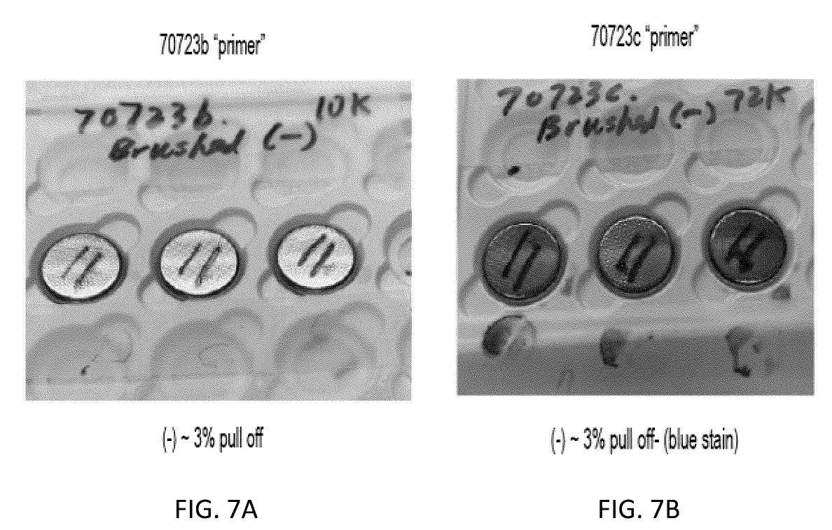

FIGS. 8A-8B illustrates the results of adhesion testing coatings applied to a cell having a primer applied with different methodologies, according to certain embodiments.

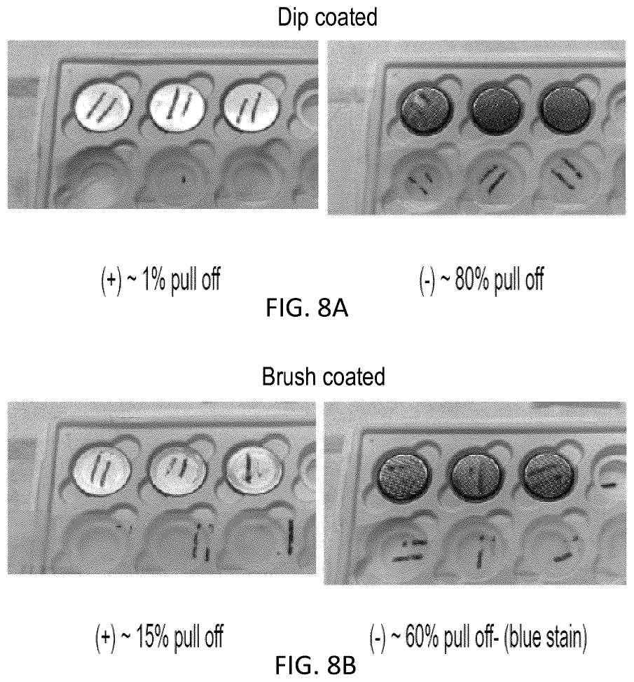

FIG. 9 shows an electrochemical cell with an aversive coating applied to the negative terminal.

FIG. 10 illustrates an example child-resistant packaging 600 according to one embodiment.

### DETAILED DESCRIPTION

Coin cell batteries, also known as button cells, are small, single-cell batteries that are typically used to power low-power devices such as watches, calculators, hearing aids, and small electronic devices. These batteries are small and compact, making them easy to use and store, and are available in a wide variety of sizes, chemistries, and voltage ratings.

Coin cell batteries were initially developed for use in hearing aids and are now used in a variety of other applications and devices, such as watches, calculators, and other small electronic devices. Coin cell batteries typically consist of a positive electrode (cathode), a negative electrode (anode), and an electrolyte that allows the flow of ions between the electrodes. The electrodes and electrolyte are enclosed in a small, circular metal casing that is typically made from stainless steel or nickel-plated brass.

The positive electrode is typically made from a metal oxide, such as silver oxide or manganese dioxide, and is coated onto a metal grid or foil. The negative electrode is typically made from a metal such as zinc or lithium, and is also coated onto a metal grid or foil. The electrolyte is typically a liquid or gel and is designed to allow the flow of ions between the electrodes.

The electrodes and electrolyte are arranged in a specific configuration within the metal casing, depending on the battery chemistry and voltage rating. For example, in a manganese dioxide-based battery, the positive electrode is placed in the center of the battery, while the negative electrode is placed around the outside of the positive electrode. This arrangement allows the battery to deliver a high voltage output while maintaining a small size.

External components include a shell or housing defining an inner volume in which the anode and electrode are housed, kept physically apart by a separator, such as an ion-permeable separator, an electrolyte-permeable separator, or the like. The anode and cathode have different active materials, such as zinc and manganese dioxide, respectively. These materials are selected for their electrochemical properties that allow them to facilitate the flow of electrons from one terminal to the other. The electrolyte is a liquid or gel substance that allows for the movement of ions between the anode and cathode. The electrolyte is often a combination of a salt, such as potassium hydroxide, and water.

Coin cell batteries are available in a wide variety of chemistries, each with its own unique performance characteristics. For example, alkaline coin cell batteries are the most common type of button cell battery and are typically used in low-power devices such as watches, calculators, and small electronic devices. These batteries use an alkaline electrolyte and a zinc-based negative electrode and are available in a wide variety of sizes and voltage ratings. Silver oxide coin cell batteries are typically used in high-power devices such as cameras, calculators, and medical equipment. These batteries use a silver oxide positive electrode and a zinc-based negative electrode and are designed to deliver a high current output and long life. Zinc-air coin cell batteries are typically used in hearing aids and use a zinc-based negative electrode and air as the positive electrode. However, these battery chemistries often have drawbacks such as off-gassing risk, explosion risk, fire risk, reduced battery life, inconsistent discharge, discharge temperature change issues, and others. Lithium is a popular alternative to other conventional battery chemistries, especially for use in low-power devices such as watches, calculators, and small electronic devices that use coin cell batteries. These batteries typically use a manganese dioxide-based positive electrode and a lithium-based negative electrode.

The principal electrochemical reaction that occurs upon ingestion of a coin cell battery is electrolysis of water because the following factors are present: (a) the coin cell itself supplies a DC voltage, ˜3V OCV (open circuit voltage); (b) an ionic conductive media (saliva) connects the anode (+) and cathode (−) terminal; and (c) the two terminals and saliva conducting path complete a closed circuit for an electrolysis cell. If the voltage supply of the electrolysis cell is high enough to overcome the polarization and the 1.23V thermodynamic voltage window for water electrolysis, electrochemical reactions will occur. Indeed, the electrolysis reaction associated with the ingestion of lithium cells is likely more severe than the electrolysis associated with ingestion of alkaline cells. This is because the driving force (the difference in voltage between the cell voltage and theoretical water electrolysis voltage, 1.23 V) is much higher in the case of a 3V lithium cell than in the case of a 1.5V alkaline cell (3.0V−1.23V=1.77V in the case of a lithium cell vs. 1.5V−1.23V=0.27V in the case of an alkaline cell).

Significantly, the nomenclature for an electrolysis cell is the opposite of that used for a battery. Accordingly, the terms “anode” and “electrolysis anode” refer to the electrode subject to an oxidation reaction and the terms “cathode” and “electrolysis cathode” refer to the electrode subject to the reduction reaction. When an electrolysis cell, such as a coin cell, is assembled and active electrochemical components are sealed within the cell, the negative terminal will be in electrical communication with the anode or electrolysis anode, while the positive terminal will be in electrical communication with the cathode or electrolysis cathode. Also, it should be noted that electrolysis requires application of voltage and, as such, provides a direct contrast to corrosion which typically occurs naturally under ambient conditions.

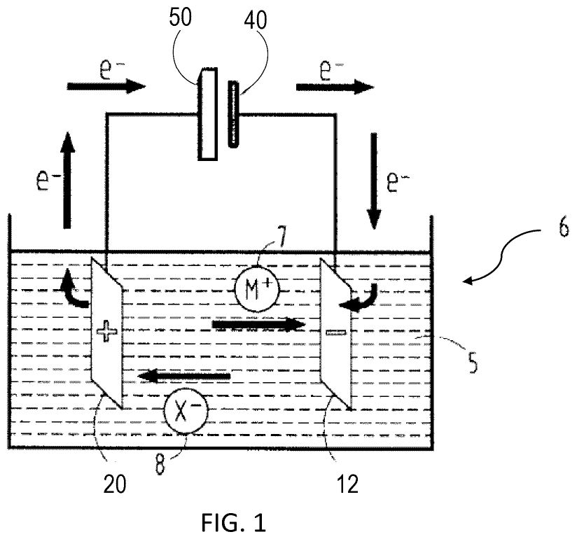

FIG. 1 helps illustrate the electrolysis reaction at issue. A simulated Li-MnO₂ electrochemical coin cell 6 submerged in saliva solution 5. The principal reactions that occur when a cell having these same components is accidentally ingested and lodged in the esophagus of a human are shown, although the cell electrodes are shown as discrete parts. Specifically, cell 6 operates at approximately 3V DC and includes coin cell cup (e.g., the positive electrode container) 12, coin cell can (e.g., the negative electrode container) 20, anode 40 and cathode 50. The anode 40 and cathode 50 comprise materials specifically selected for their compatibility with an intended electrochemical reaction; for example, x Li+MnO₂→Li-MnO₂, in which the Mn undergoes a reduction as the lithium ion enters into the crystal lattice.

The external surface of the coin cell cup 12 acts as the negative terminal (cathode in an electrolysis cell) and the external surface of the coin cell can 20 acts as the positive terminal (anode in an electrolysis cell). A hydrogen gas evolution reaction takes place on coin cell cup 12 by accepting electrons from battery anode 40, which in this case includes lithium. At the coin cell can 20 (anode in an electrolysis cell), multiple reactions such as metallic dissolution, oxygen gas evolution and possibly chloride oxidation occur and compete with one another. Charge neutrality in saliva solution 5 is preserved by the movement of anions 8 from the cell cup 12 (negative terminal) toward coin cell can 20 (positive terminal) and by the movement of cations 7 in the opposite direction. As metal from coin cell can 20 oxidizes, it loses electrons to battery cathode 50, which is manganese dioxide in this case. Ultimately, the final product at the coin cell can 20 depends on its potential and the solution pH is a consequence of the combined anode and cathode reactions. Further, the solution pH reflects real time product generated in the reaction zone between the esophagus and coin cell; therefore, the solution pH is localized and not necessarily reflective of the pH of the bulk solution (i.e., the remainder of the saliva which is not proximate to the reaction zone).

Possible electrochemical reactions on the coin cell cup 12 (negative terminal) are shown below when a 3 V lithium coin cell is immersed in a neutral or alkaline saliva solution. Note that the saliva is usually neutral.

2H₂O+2e⁻→H2↑+2OH⁻E₀=— 0.83V (1)

O₂+2H₂O+4e⁻→4OH⁻E₀=— 0.4V (2)

Typically, reaction (1) dominates because the concentration of oxygen in the saliva is too low as the solubility of oxygen in water is limited. Either way, the production of hydroxyl ions (i.e., OH⁻) increases the pH of the saliva, potentially to a point that may cause alkaline burning of the esophagus.

On occasion, saliva may be acidic in nature. In such situations, the reactions at the coin cell cup 12 are shown below:

2H⁺+2e⁻→H₂↑E₀=−0.0V (1a)

O₂+4H⁺+4e⁻→2H₂O E₀=1.23 V (2a)

In either case, selection of materials for use at the negative terminal with high hydrogen gas evolution overpotential will shift the dominant reaction from (1) and (2) to (1a) and (2a). This has the beneficial effect of reducing or eliminating the hydroxyl formation that can cause localized alkaline burning of esophageal tissues.

Possible electrochemical reactions on the coin cell can 20 (positive terminal) are shown below when a 3V lithium coin cell is immersed in saliva solution 5 and coin cell can 20 comprises nickel at least partially along its surface.

4OH⁻−4e⁻→O₂↑+2H₂O (3)

Ni−2e⁻+2OH⁻→Ni(OH)₂ (4)

Reaction (4) usually dominates so that the metal constituents in coin cell can 20 tend to oxidize. Indeed, lithium electrochemical coin cell cans are typically nickel-plated, as exemplified by the oxidation of nickel in reaction (4). If coin cell can 20 is composed of other metals, e.g., stainless steel, the iron in these alloys likely will oxidize in a similar reaction. Once the metal surface of coin cell can 20 has been passivated (i.e., by formation of a dense oxide film on the bare metal surface), the oxygen evolution reaction (3) will likely dominate if the voltage is sufficiently high.

Moreover, as shown below in (3a) and (4a), dissolution of the metal can 20 is also a probable result if the ferrous base metal (normally some type of steel) is exposed and especially to the extent that hydroxide is present (e.g., by way of the aforementioned competing reactions) and/or in an acidic environment (e.g., by way saliva).

Fe−2e⁻→Fe²⁺ (in acidic media) (3a)

Fe−2e⁻+2OH⁻→Fe(OH)₂ (in alkaline media) (4a)

Any combination of the cathodic processes in reactions (1) through (2a) and anodic processes in reactions (3) through (4a) can complete the electrolysis cell 6 depicted in FIG. 1. For example, the combination of (1) and (3) leads to the following electrolysis reaction in water (i.e., water splitting):

2H₂O→H₂↑+O₂↑E₀=−1.23 V (5)

Note that electrolysis reaction (5) has a thermodynamic potential of 1.23 V and the negative sign for ΔE₀ denotes that the reaction is not spontaneous. Consequently, a DC power source of at least 1.23 V is needed to initiate and sustain reaction (5) and, as depicted in FIG. 1, coin cell 6 supplies 3V DC.

Furthermore, if the amount of sodium chloride (NaCl) in the saliva is relatively high, the following electrolysis reaction may occur instead of reaction (5) (discussed earlier):

2NaCl+2H₂O→Cl₂↑+H₂↑+2NaOH (6)

In reaction (6), one of the products is sodium hydroxide (NaOH), another contributor to high solution pH and a potentially alkaline solution that may be capable of burning human tissue.

In sum, the conventional electrochemical coin cell 6 depicted in FIG. 1, and the reactions (1) through (6) associated with its submersion in saliva 5, demonstrate that hydroxide ions are formed from some iteration of electrolysis. Thus, the burns and injuries caused when a coin cell becomes accidentally lodged in the esophagus is likely caused by the high saliva pH created during these reactions, although the reactions and corresponding impact on pH may be highly localized and difficult to detect if the pH is not measured in close proximity to the components at issue. Stated differently, because of mass transport limitations in the esophagus, a person with a lodged coin cell may experience different pH values for the tissue interacting with coin cell can 20 (positive terminal) and the tissue interacting with coin cell cup 12 (negative terminal), with higher pH solutions facing the negative terminal (i.e., coin cell cup 12 in FIG. 1) because of diffusion limitations of the liquids within the esophagus.

To the extent certain aspects of various embodiments of the present disclosure and underlying concepts involve saliva and/or saliva-based aqueous solutions, saliva can be represented by the following composition: 0.4 g KCl; 0.4 g NaCl; 0.906 g CaCl₂; 0.560 g Na₃PO₄⁻12H₂O; 2 ml 10% H₃PO₄; 0.0016 g Na₂S; 1 g urea; and a balance of de-ionized water to make 1 liter of solution. While this formulation is intended to approximate human saliva in a manner that is standardized, small variations and/or actual human saliva may be used as substitutes although, in such instances, deviations from the representative formulation will be duly noted.

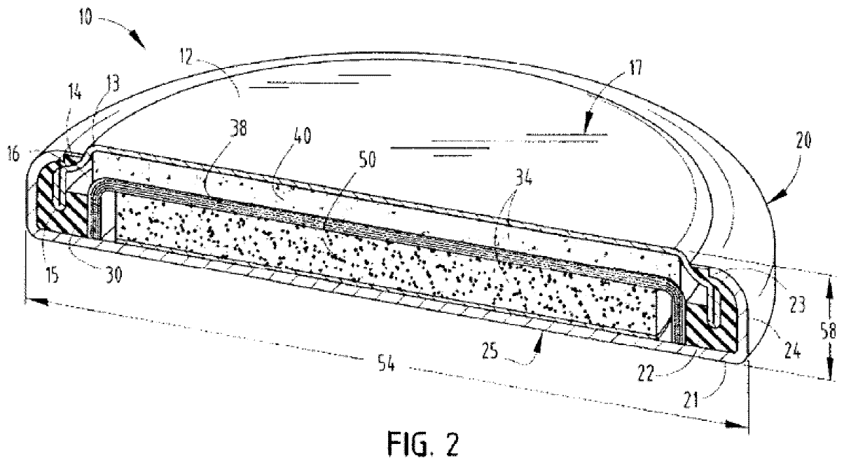

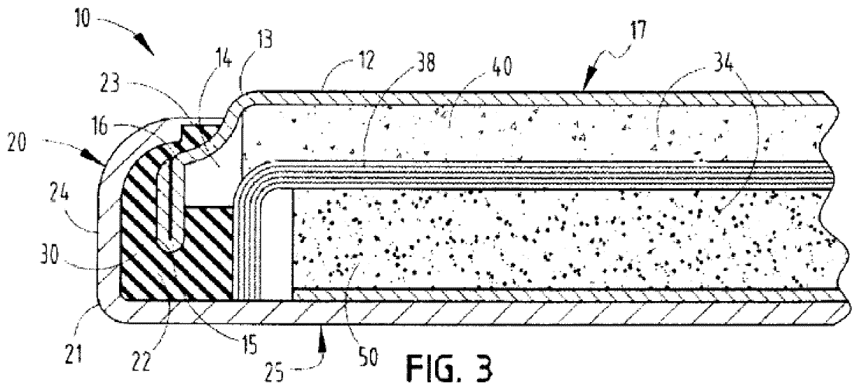

FIGS. 2 and 3 depict one arrangement for an electrochemical coin cell 10 that is well-suited to aspects and embodiments of the present disclosure, although the coin cell 10 may assume various alternative orientations and arrangements of components. Further, the specific devices and processes illustrated in the attached drawings and described herein are exemplary embodiments of the inventive concepts defined in the appended claims. Hence, precise dimensions and physical characteristics relating to the embodiments disclosed herein are not to be considered as limiting except to the extent that such dimensions or characteristics are inherent to producing the desired reactions.

The electrochemical coin cell 10, as depicted in FIGS. 2 and 3, also includes a cathode terminal 20 (i.e., the cell can) including a closed end 21, an open end 22 with a terminal edge 23, and a side wall 24 extending between closed end 21 and open end 22. Cathode terminal 20 serves as the positive electrode for the coin cell. In addition, cathode terminal 20 comprising a metallic material, such as titanium, a titanium alloy, titanium nitride, tantalum, niobium, stainless steel, gold, boron-doped diamond, or another electronic conductor. Closed end 21 may also be provided with a composition comprising titanium metal, a titanium alloy, titanium nitride, tantalum, niobium, stainless steel, gold, boron-doped diamond, or another electronic conductor.

Coin cell 10 further includes a gasket 30 that provides a seal between anode terminal 12 and cathode terminal 20 (FIGS. 2 and 3). The gasket 30 is typically made from an electrically nonconductive, elastomeric material, capable of providing a compressive seal between anode terminal 12 and cathode terminal 20. The material used for gasket 30 must also be selected with reference to its stability in the presence of an electrolyte, its resiliency and its resistance to cold flow. Suitable materials for gasket 30 include the following: nylon, polytetrafluoroethylene, fluorinated ethylene-propylene, chlorotrifluoroethylene, perfluoroalkoxy polymer, polyvinyls, polyethylene, polypropylene, polystyrene, polysulfone and the like.

The electrochemical coin cell 10 also includes an electrolyte 34. Various materials can be employed for electrolyte 34 as understood by one with ordinary skill in the art. For example, electrolyte 34 may be composed of a composition of at least one lithium salt dissolved in an organic solvent or a blend of organic solvents. Suitable salts for use in lithium coin cells are lithium trifluoromethanesulfonate, lithium trifluoromethanesulfonimide, lithium perchlorate, lithium tetrafluoroborate, lithium hexafluorophosphate, or their combination. Common organic solvents used in lithium coin cells are propylene carbonate and 1,2-dimethoxyethane.

The electrochemical cell 10 also has an anode 40 disposed in electrical connection with anode terminal 12. As understood by those with ordinary skill in the art, the anode 40 can be composed of various alkaline metals and their alloys with aluminum or magnesium provided that the composition is suitable for serving as an anode in an electrochemical cell. In one embodiment, anode 40 is primarily composed of lithium material suitable as an anode in an electrochemical cell with a cathode that consists primarily of manganese dioxide.

Electrochemical cell 10 also includes cathode 50 arranged to be in electrical connection with cathode terminal 20. As also understood by those with ordinary skill in the art, cathode 50 can be composed of various materials suitable for use as a cathode in a lithium-based electrochemical cell. In one embodiment, cathode 50 is primarily composed of manganese dioxide.

Electrochemical coin cell 10 further includes a separator 38 disposed between anode 40 and cathode 50 for providing insulation therebetween. Separator 38 can be composed of any of a variety of polymeric materials, for example, that provide electrical insulation between anode terminal 12 and cathode terminal 20. For example, separator 38 may be formed from a polypropylene or polyethylene nonwoven film with thickness of between about 20 μm and about 60 μm.

As also demonstrated by FIGS. 2 and 3, electrochemical cell 10 can be configured in a button-or coin-cell configuration with a total cell external diameter 54 and total cell height 58. The total cell external diameter 54 may be sized from between about 5 mm and about 25 mm and the total cell height 58 may be between about 0.5 mm and about 10 mm. It is generally understood that button or coin cells with these dimensions are most likely to lodge in the esophagus upon accidental ingestion. For example, electrochemical cell 10 may be made in a CR2016 configuration as defined by the International Electrotechnical Commission (IEC) with total cell external diameter 54 having a diameter of about 20 mm and total cell height 58 having a thickness of about 1.6 mm.

Another aspect of the disclosed approach relates to a method of constructing and/or manufacturing a coin cell having the features discussed herein. The method comprises providing a negative electrode active material comprising lithium and disposing said materials in separate halves of an electrically conductive container and providing a nonaqueous, organic liquid electrolyte prior to hermetically sealing the halves of the conductive container to create a battery.

Another aspect of the disclosed approach is the provision and/manufacture of an battery to avoid injuries associated with ingestion of said battery, as well as a method of for avoiding injuries caused by battery ingestion. In these aspects, any of the aforementioned battery designs and constructions may be provided. At their core, the inventive method involves manufacturing an battery and providing said battery for sale and/or use by a consumer.

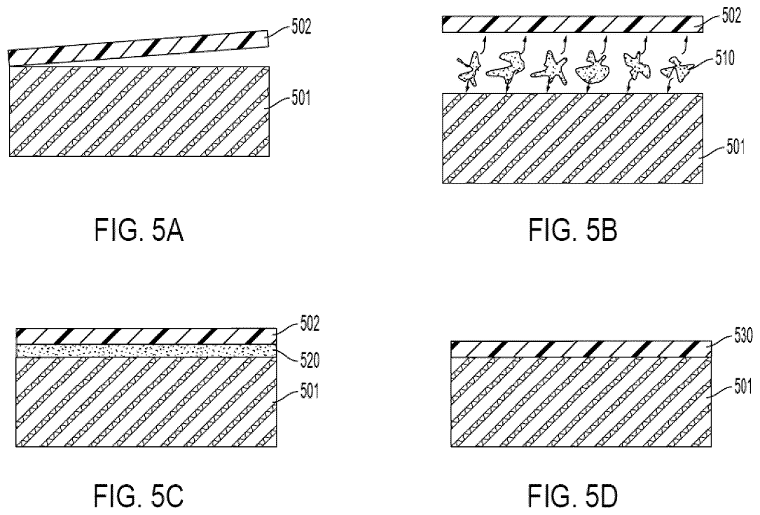

As shown in FIG. 5A, without additional preparation an aversive coating 502 may not adequately adhere to the exterior surface of an electrochemical cell 501. In one approach to address this challenge, the surface of the electrochemical cell is treated with compositions 510 which can anchor the battery surface 501 to the polymer in the aversive coating 502, as shown in FIG. 5B. Another approach shown in FIG. 5C involves depositing a thin layer of a primer 520 on the battery surface 501 before applying the aversive coating 502. Other embodiments include adding compositions such as adhesion promoters and/or surfactants to the aversive coatings 530 to facilitate adhesion to the battery surface 501, as shown in FIG. 5D.

### Aversive Coatings

Aspects of the disclosure relate to aversive coatings for electrochemical cells. An aversive coating is formed by applying a solution comprising an aversive agent composition and a binder, such as a water-soluble polymer onto a surface (e.g., a surface of a battery) and allowing the solution to dry. The aversive agent composition comprises at least one aversive agent, which can be an aversive taste agent such as a bitterant, an aversive smell agent, or a salivating agent. An “aversive taste agent” refers to a substance which is bitter, sour, spicy, peppery, or otherwise undesirable in flavor to deter children from eating a battery. An “aversive smell agent” is an odiferous substance with an undesirable smell, such as ammonia or sulfur. A “salivating agent” refers to a substance which induces the production of saliva when in contact with the mouth. The aversive agent composition may also comprise a colorant to alert parents that a child has tried to consume a battery.

In some embodiments, the aversive coating has a dry-weight composition comprising 0.5 wt % to 65 wt % of an aversive agent composition and 5 wt % to 98.5 wt % of a water-soluble polymer. In some embodiments, the aversive coating comprises one or more additives balancing the dry-weight composition.

The aversive agent composition comprises at least one aversive taste agent. In some embodiments, the aversive taste agent is selected from: denatonium benzoate (DNB), capsaicin, allyl isothiocyanate, or piperine. In some embodiments, the aversive taste agent is DNB. In some embodiments, the aversive coating has a dry-weight composition comprising 0.5 wt % to 8.0 wt % of the aversive taste agent (e.g., DNB). In some embodiments, the aversive coating has a dry-weight composition comprising about 5.0 wt % to about 7.0 wt % DNB. In some embodiments, the aversive coating has a dry-weight composition comprising about 6.0 wt % DNB.

The water-soluble polymer contained in the aversive coatings acts as a binder to adhere the aversive agent compositions to the electrochemical cell. In some embodiments the dry-weight composition of the aversive coating comprises 10 wt % to 98.5 wt %, 15 wt % to 95 wt %, 20 wt % to 90 wt %, 30 wt % to 80 wt %, 35 wt % to 70 wt %, 35% to 60%, 35 wt % to 50 wt %, or 35 wt % to about 45 wt % of the water-soluble polymer. In some embodiments, the dry-weight composition of the aversive coating comprises about 41 wt % of the water-soluble polymer.

In some embodiments, the water-soluble polymer is selected from: polyvinyl alcohol (PVA), polyacrylic acid (PAA), polyacrylamide, or polyethylene glycol (PEG). In some embodiments the water-soluble polymer is PVA. In some embodiments, the water-soluble polymer has a molecular weight of about 10,000 to about 150,000, about 10,000 to about 100,000, about 50,000 to about 100,000, about 60,000 to about 90,000, about 70,000 to about 80,000, or about 75,000. In some embodiments, the PVA has a molecular weight of about 10,000 to about 150,000,about 10,000 to about 100,000, about 50,000 to about 100,000, about 60,000 to about 100,000, about 60,000 to about 90,000, about 70,000 to about 100,000, about 70,000 to about 90,000 about 70,000 to about 80,000. In some embodiments, the PVA has a molecular weight of about 75,000. All molecular weights are described as an average mass in grams per mole.

Polyvinyl alcohol is prepared from polyvinyl acetate by hydrolyzing ester functional groups to hydroxyl functional groups. The degree to which polyvinyl alcohol has been hydrolyzed can vary. For PVA that has been 80% hydrolyzed, approximately 80% of the monomer units contain hydroxyl groups and approximately 20% of the monomer units contain acetate. In some embodiments, the PVA is about 70% to 100% hydrolyzed, about 70% to about 99% hydrolyzed, about 80% to about 99% hydrolyzed, about 85% to about 95% hydrolyzed, about 80% to about 90% hydrolyzed, or about 85% to about 90% hydrolyzed. In some embodiments, the PVA is about 80% to about 95% hydrolyzed. In some embodiments, the PVA is about 88% hydrolyzed. In some embodiments, the PVA has a molecular weight of about 75,000 and is about 88% hydrolyzed.

In some embodiments, one or more additives of the aversive coating comprise an adhesion promoter. In some embodiments, the dry-weight composition of the aversive coating comprises 0.1 wt % to about 5.0 wt % of the adhesion promoter. In some embodiments, the adhesion promoter is Lubrizol 2063, Lubrizol 2062, DowSil Z-6137, DowSil 3-6121, PP-6 (PP water from Marabin Environmental Conservation Printing Ink Co. Ltd), BYK-4509, or BYK-4510. In some embodiments, the adhesion promoter is Lubrizol 2063, a hydroxy and carboxy functionalized phosphate ester. In some embodiments, the dry-weight composition of the aversive coating comprises 2.0 wt % to 5.0 wt % Lubrizol 2063. In some embodiments, the dry-weight composition of the aversive coating comprises about 4.1 wt % Lubrizol 2063.

In some embodiments, one or more additives of the aversive coating comprise a surfactant. In some embodiments, the dry-weight composition of the aversive coating comprises 0.01 wt % to about 0.5 wt % of the surfactant. In some embodiments, the surfactant is an alkyl sulfate, an alkyl ether sulfate, an alkyl benzene sulfonate, a polyoxyethylene ether, a phosphate ester, or a carboxylate. In some embodiments, the surfactant is sodium dodecyl sulfate (SDS), sodium lauryl ether sulfate (SLES), sodium stearate, Triton X-100, polysorbate 20 (Tween® 20), or dioctyl sodium sulfosuccinate (DOSS). In some embodiments, the surfactant is sodium dodecyl sulfate (SDS). In some embodiments, the dry-weight composition of the aversive coating comprises about 0.4 wt % SDS.

In some embodiments, zone or more additives of the aversive coating comprise a viscosity modifier to aid in dispensing a solution comprising the aversive coating. In some embodiments, the dry-weight composition of the aversive coating comprises 0.01 wt % to about 2.0 wt % of the viscosity modifier. In some embodiments, the viscosity modifier is a carbomer, a high molecular weight synthetic polymer of acrylic acid and allyl sucrose or allyl pentaerythritol, such as Carbopol® (e.g., Aqua SF-1, Aqua SF-3, Aqua CC, Silk 100, SC-800, 980 polymer, Ultrez 10, Ultrez 21) or Pemulen™ (e.g., TR-1, TR-2, EZ-4U). In some embodiments, the viscosity modifier is polyethylene glycol (PEG), which can have various molecular weights, such as PEG-400. In some embodiments, the viscosity modifier is a natural polysaccharide, such as xanthan gum, guar gum, or cellulose gum. In some embodiments, the viscosity modifier is a cellulose derivative such as carboxymethyl cellulose (CMC) or hydroxyethyl cellulose (HEC). Examples of viscosity modifiers include but are not limited to Viscolam®, Esaflor®, Ammonyx®, Ninol®, and Amphosol® thickening agents. In some embodiments, the viscosity modifier is carboxymethyl cellulose (CMC).

In some embodiments, the aversive agent composition further comprises a colorant. In some embodiments the dry-weight composition of the aversive coating comprises 0.5 wt % to 60 wt % of a colorant. In some embodiments the dry-weight composition of the aversive coating comprises 5 wt % to 55 wt %, 10 wt % to 55 wt %, 20 wt % to 55 wt %, 30 wt % to 55 wt %, 40 wt % to 55 wt %, or 45 wt % to 55 wt % of the colorant. In some embodiments, the colorant comprises FD&C Blue No. 1 (Brilliant Blue FCF), FD&C Blue No. 2 (Indigotine), FD&C Green No. 3 (Fast Green FCF), FD&C Red No. 3 (Erythrosine), FD&C Red No. 40 (Allura Red AC), FD&C Yellow No. 5 (Tartrazine), or FD&C Yellow No. 6 (Sunset Yellow). The colorant may also comprise natural organic dyes such as Veg Blue WS180 or Veg Bright Yellow CWD25 available from FoodRGB, Inc. In some embodiments, the dry-weight composition of the aversive coating comprises about 45 wt % to about 55 wt % FD&C Blue No. 1. In some embodiments, the dry-weight composition of the aversive coating comprises about 50 wt % FD&C Blue No. 1.

In one embodiment, the aversive coating has a dry-weight composition comprising about 5.0 wt % to about 7.0 wt % DNB, about 35 wt % to about 45 wt % PVA, and about 45 wt % to about 55 wt % FD&C Blue No. 1. In one embodiment, the aversive coating has a dry-weight composition comprising about 5.0 wt % to about 7.0 wt % DNB, about 35 wt % to about 45 wt % PVA, 45 wt % to about 55 wt % FD&C Blue No. 1, and about 2.0 wt % to about 5.0 wt % Lubrizol 2063. In one embodiment, the aversive coating has a dry-weight composition comprising about 5.0 wt % to about 7.0 wt % DNB, about 35 wt % to about 45 wt % PVA, 45 wt % to about 55 wt % FD&C Blue No. 1, and about 0.4 wt % SDS. In one embodiment, the aversive coating has a dry-weight composition comprising about 5.0 wt % to about 7.0 wt % DNB, about 45 wt % to about 55wt % PVA, 45 wt % to about 55 wt % FD&C Blue No. 1, about 2.0 wt % to about 5.0 wt % Lubrizol 2063, and about 0.4 wt % SDS.

In one embodiment, the aversive coating has a dry-weight composition comprising about 5.0 wt % to about 6.0 wt % DNB, about 40 wt % to about 50 wt % PVA, 40 wt % to about 50 wt % FD&C Blue No. 1, and about 1 wt % to about 2 wt % CMC.

In one embodiment, the aversive coating has a dry-weight composition comprising about 1.0 wt % to about 6.0 wt % capsaicin, about 40 wt % to about 50 wt % PVA, and 40 wt % to about 50 wt % FD&C Blue No. 1.

In one embodiment, the aversive coating has a dry-weight composition comprising about 5.0 wt % to about 6.0 wt % DNB, about 40 wt % to about 50 wt % PVA, 40 wt % to about 50 wt % FD&C Blue No. 1, and about 1.0 wt % to about 5.0 wt % DowSil Z-6137.

In one embodiment, the aversive coating has a dry-weight composition comprising about 13 wt % to about 20 wt % DNB, and about 75 wt % to about 87% PVA. In one embodiment, the aversive coating has a dry-weight composition comprising about 13 wt % to about 20 wt % DNB, about 75 wt % to about 87% PVA, and about 2.0 wt % to about 3.0 wt % Lubrizol 2063. In one embodiment, the aversive coating has a dry-weight composition comprising about 13 wt % to about 20 wt % DNB, about 75 wt % to about 87% PVA, and about 0.1 wt % to about 0.5 wt % SDS.

In one embodiment, the aversive coating has a dry-weight composition comprising about 2.0 wt % to about 6.0 wt % DNB, about 70 wt % to about 80 wt % polyacrylic acid (PAA), and about 5 wt % to about 28 wt % FD&C Blue No. 1. In one embodiment, the aversive coating has a dry-weight composition comprising about 2.0 wt % to about 6.0 wt % DNB, about 70 wt % to about 80 wt % polyacrylic acid (PAA), about 5 wt % to about 28 wt % FD&C Blue No. 1 and about 1 wt % to about 2 wt % CMC.

### Electrochemical Cells

Aspects of the disclosure relate to electrochemical cells at least partially coated in one or more of the aversive coatings described herein. The electrochemical cells comprise a positive terminal defining a first portion of an exterior of the electrochemical cell; a negative terminal that is electrically insulated from the positive terminal and defining a second portion of the exterior of the electrochemical cell; an anode positioned within an interior of the electrochemical cell and in electrical connection with the negative terminal; and a cathode positioned within the interior of the electrochemical cell, wherein the cathode is electrically separated from the anode and is in electrical connection with the positive terminal. At least part of the exterior of the electrochemical cell is prepared for adhesion with the aversive coating by applying a composition to the exterior of the electrochemical cell to form a prepared exterior portion. The prepared exterior portion is coated with the aversive coatings provided herein.

In some embodiments, the electrochemical cell is a button cell or a coin cell. In some embodiments, the electrochemical cell is a lithium coin cell. Lithium coin cells include but are not limited to CR1025, CR1216, CR1616, CR1620, CR1632, CR2016, CR2025, CR2032, CR2430, and CR2450 batteries. Coin cell batteries commonly have diameters of 10 mm, 12.5 mm, 16 mm, 20 mm, and 24 mm, which provide terminal areas of approximately 79 mm², 123 mm², 201 mm², 314 mm², and 452 mm² respectively.

In some embodiments, the electrochemical cell is prepared for adhesion by applying a primer to the electrochemical cell prior to applying the aversive coating. The primer comprises a water-soluble polymer, which may be the same or different from the water-soluble polymer used in the aversive coating. For example, the aversive coating may comprise PVA while the primer comprises PAA. Additionally, the molecular weight and degree of hydrolysis may vary between the aversive coating and the primer. For instance, the aversive coating may comprise PVA with a molecular weight of about 75,000 that is about 88% hydrolyzed while the primer comprises PVA with a molecular weight of about 50,000 that is about 80% hydrolyzed. Utilizing a different polymer in the primer and the coating may provide beneficial effects for binding the coating to the exterior of the battery, while maintaining a low overall thickness of the primer and coating. For example, the primer may utilize a lower-molecular weight polymer, which may facilitate the application of a thin primer thickness, and the coating may utilize a higher-molecular weight polymer that may facilitate adhesion of the aversive agent composition to the primer (and the surface of the battery). The primer has a dry-weight composition comprising at least 50 wt % of the water-soluble polymer, such as PVA or PAA. The primer is applied as a thin coating with a thickness of less than 1 μm to avoid interfering with the performance of the battery. It may be desirable for the primer to have a thickness of less than 0.8 μm, or less than 0.6 μm. The total dry weight of the primer applied to each electrochemical cell may be about 0.1 mg to about 0.5 mg, preferably about 0.1 mg to about 0.2 mg.

The primer may further comprise one or more additives such as an adhesion promoter and/or a surfactant to help the primer adhere to the surface of the electrochemical cell. The dry-weight of the primer may comprise up to 50 wt % of the adhesion promoter and/or the surfactant. In some embodiments, the primer comprises Lubrizol 2063, Lubrizol 2062, DowSil Z-6137, DowSil 3-6121, or PP-6. In some embodiments, the primer comprises SDS. In some embodiments, the primer further comprises up to 10 wt % of an aversive taste agent, such as DNB. Additives in the primer, such as adhesion promoters which bind to the metal surface of the battery casing, improve the adherence of the primer to the surface of the electrochemical cell. The application of the primer prepares an exterior portion of the electrochemical cell for adhesion to the aversive coating as the water-soluble polymer in the aversive coating can form strong interactions with the water-soluble polymer in the primer. Thus, the application of a primer can improve the adherence of an aversive coating to an electrochemical cell.

In some embodiments, the electrochemical cell is prepared for adhesion by applying a surface treatment composition to the electrochemical cell prior to applying the aversive coating. The application of the surface treatment composition may prepare an exterior portion of electrochemical cell for adhesion to the aversive coating by cleaning, etching, or activating the battery casing surface, or by binding to the battery casing and the water-soluble polymer in the aversive coating. The surface treatment composition may comprise an adhesion promoter and/or a surfactant, or an acid to prepare the surface of the electrochemical cell for better adherence to the aversive coating. In some embodiments, the surface treatment composition comprises Lubrizol 2063, Lubrizol 2062, DowSil Z-6137, DowSil 3-6121, or PP-6. In some embodiments, the surface treatment comprises SDS. In some embodiments, the surface treatment composition comprises an aqueous acid solution such as nitric acid, sulfuric acid, hydrochloric acid, or phosphoric acid. The acid solution may have a concentration of approximately 1 N.

In some embodiments, greater than 2% by area, greater than 3% by area, greater than 4% by area, greater than 5% by area, greater than 10% by area, greater than 20% by area, greater than 30% by area, greater than 40% by area, greater than 50% by area, greater than 60% by area, greater than 70% by area, greater than 80% by area, or greater than 90% by area of the positive terminal and/or negative terminal is prepared for adhesion. All or part of the prepared exterior portion may be coated with the aversive coating. In one example, the entire exterior surface of the electrochemical cell is coated in a thin layer of primer followed by a thin layer of the aversive coating. In another example, the entire surface of the negative or positive terminal is coated with a thin layer of primer and the aversive coating is applied to portions of the terminal coated in primer. In yet another example, the entire exterior surface of the electrochemical cell is surface treated and portions of the positive or negative terminal are coated with the aversive coating.

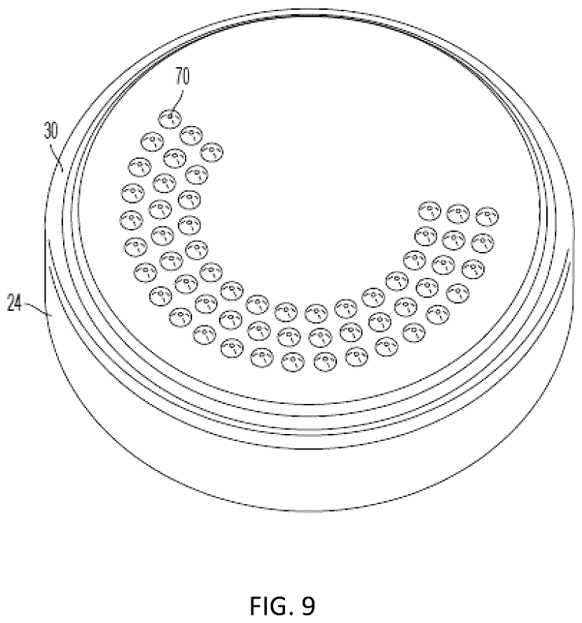

FIG. 9 shows an example of a coin cell with the aversive coating applied to portions of the exterior surface of the negative terminal. In the illustrated example, the aversive coating is applied in a series of dots 70 collectively covering a portion of a negative terminal. The series of dots is provided to form an arc on the surface of the battery. However, it should be understood that other patterns may be used, such as stripes, rings, ovals, squares, rectangles, and diamonds. To prevent or reduce interference with the performance of the battery, the aversive coating may be located inside of a diameter of about 14.0 mm and outside of a diameter of about 8.2 mm from the center of a terminal of a coin cell. In some embodiments, the aversive coating is not located on the side wall 24 of the gasket 30.

In some embodiments, greater than 50% by area of an exterior surface of the positive terminal is coated by the aversive coating. The exterior surface 25 of the positive terminal 20 is shown in FIGS. 2 and 3.

In some embodiments, greater than 50% by area of an exterior surface of the negative terminal is coated by the aversive coating. The exterior surface 17 of the negative terminal 12 is shown in FIGS. 2 and 3.

In some embodiments, the side wall of the gasket is not coated with the aversive coating. The side wall 24 of the gasket 30 is shown in FIGS. 2 and 3.

In some embodiments, the dry weight of the total amount of aversive coating applied to the electrochemical cell is about 0.1 mg to about 1.2 mg. In some embodiments, the dry weight of the total amount of aversive coating applied to the electrochemical cell is about 0.2 mg to about 0.5 mg. In some embodiments, the dry weight of the total amount of aversive coating applied to the electrochemical cell is about 0.4 mg.

In some embodiments, the total amount of aversive taste agent applied to the electrochemical cell is between 1 μg to 120 μg, between 5 μg to 100 μg, between 5 μg to 50 μg, between 10 μg to 50 μg, between 10 μg to 40 μg, between 10 μg to 30 μg, between 10 μg to 25 μg, between 20 μg to 40 μg, or between 20 μg to 30 μg. In some embodiments, the total amount of aversive taste agent applied to the electrochemical cell is about 25 μg. In some embodiments, the aversive taste agent is provided in both the primer and the aversive coating.

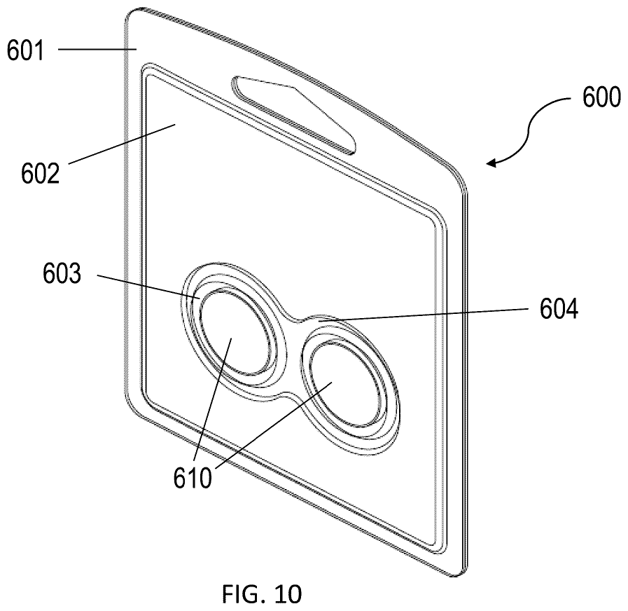

In some embodiments, the electrochemical cell is packaged for sale in child-resistant packaging. The embodiment of FIG. 10 shows two batteries 610 positioned within the child-resistant packaging 600, although it should be understood that one battery or more than two batteries may be packaged within a single child-resistant packaging in other example embodiments. As shown, the child-resistant packaging may be embodied as a blister package, having a planar cardboard backing 601 and an overlaid thermoformed plastic layer 602 adhered onto a surface of the planar cardboard backing 601. In the illustrated embodiment, the thermoformed plastic layer 602 comprises a battery-holding portion 603 that is shaped to hold the one or more batteries that are enclosed within the packaging. The battery-holding portion 603 has an open end and defines a depression sized such that the one or more batteries fits entirely within the battery-holding portion 603, such that the planar cardboard backing 601 can be secured across the open end of the depression. Moreover, the plastic layer 602 additionally comprises a stiffening ridge encircling the battery-holding portion 603. The stiffening ridge 604 is hollow and extends in the same direction as the battery-holding portion 603. The stiffening ridge 604 provides additional stiffness to the child-resistant packaging 600, to impede a child from bending the child-resistant packaging 600 to release a battery stored therein.

The plastic layer 602 may comprise any of a variety of thermoplastics. For example, the plastic layer may be polyvinyl chloride (PVC), although other plastic materials may be utilized. The plastic layer may be sufficiently thick as to prevent a child from tearing the plastic layer. For example, the plastic layer may have a thickness of greater than 3 mil (e.g., between 3-7 mil).

As mentioned, the plastic layer 602 may be adhered to the planar cardboard backing 601 using an adhesive. For example, the adhesive may be a polyurethane-based adhesive, although other adhesives may be utilized. Greater than 50% of the area of the planar cardboard backing 601 may be adhered to planar portions of the plastic layer 602. A higher percentage of planar cardboard backing 601 being adhered to the plastic layer 602 increases the difficulty of a child removing the planar cardboard backing 601 from the plastic layer 602, thereby releasing the batteries therefrom. Accordingly, certain embodiments may adhere greater than 60%, greater than 70%, greater than 80%, or greater than 90%, by area, of the planar cardboard backing 601 onto the plastic material 602.

Moreover, as shown in FIG. 10, the plastic layer 602 may be sized to cover the entire area of planar cardboard backing 601. In this way, a child cannot bend the planar cardboard backing 601 to delaminate or otherwise release the plastic layer 602 from the surface of the planar cardboard backing 601.

### Methods of Preparing Electrochemical Cells With Aversive Coatings

Described are methods of making the electrochemical cells coated in aversive coatings. The electrochemical cells disclosed herein may be manufactured following any method known in the art. The method comprises preparing at least a part of the exterior of the electrochemical cell for adhesion with an aversive coating by applying a primer or a surface treatment. A primer solution or a surface treatment solution is prepared, applied to the electrochemical cell and dried prior to applying a coating solution to form the aversive coating.

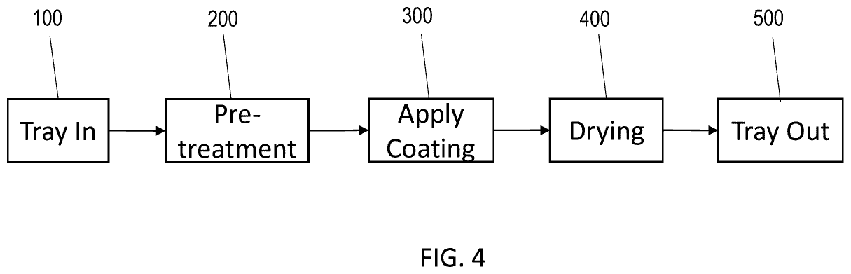

As shown in FIG. 4, a method of making the coated electrochemical cells on an assembly line may comprise bringing in a tray of electrochemical cells following manufacture 100, performing a pre-treatment process 200, applying the coating solution 300, drying the coating on the electrochemical cell 400, and bringing the tray out 500 for packaging.

The exterior surfaces of electrochemical cells may be cleaned after manufacture of the electrochemical cell, the cleaning may occur as a part of the pre-treatment process 200 and prior to applying the coating solution 300. In certain embodiments, the pre-treatment process 200 comprises applying a primer solution or a surface-treatment solution to the electrochemical cell and drying the primer or surface-treatment before applying the coating solution to form the aversive coating.

Cleaning the surface of the electrochemical cell may remove grease or residue from the manufacturing process, which may facilitate adherence of the coating solution to the electrochemical cell. In some embodiments the electrochemical cell is sprayed with deionized water for a period of time (e.g., 5 to 10 seconds) prior to applying the coating solution. In some embodiments, the electrochemical cell is rinsed at a temperature higher than room temperature (e.g., 27° C. to 35° C.). The electrochemical cell may be dried prior to applying the coating solution. In some embodiments, the electrochemical cell is dried with hot air after rinsing for a period of time (e.g., 1 to 5 seconds). In some embodiments, the electrochemical cell is dried with air at a temperature of about 25° C.

In embodiments that utilize a primer solution, the primer solution is prepared by dissolving 0.1 wt % to 0.5 wt % of a water-soluble polymer, such as PVA or PAA, in a solvent. In some embodiments, the primer solution further comprises 0.001 wt % to 0.5 wt % of an adhesion promoter. In some embodiments, the adhesion promoter is Lubrizol 2063, Lubrizol 2062, DowSil Z-6137, DowSil 3-6121, or PP-6. In some embodiments, the primer solution comprises about 0.1 wt % Lubrizol 2063. In some embodiments, the primer solution further comprises 0.001 wt % to 0.5 wt % of a surfactant such as SDS. In some embodiments, the primer solution comprises about 0.1 wt % SDS. In some embodiments, the primer solution further comprises 0.01 wt % to 2.0 wt % of a viscosity modulator such as CMC. In some embodiments, the primer solution further comprises 0.001 wt % to 0.02 wt % of the aversive taste agent such as DNB. As discussed herein, the primer solution may be applied directly to the surface of the electrochemical cell (e.g., the entire surface of the electrochemical cell or a portion of the surface of the electrochemical cell). In other embodiments, the primer solution may be mixed with the coating solution prior to applying the same to at least a portion of the electrochemical cell.

In embodiments that utilize a surface treatment solution (with or without the use of a primer solution), the surface treatment solution is prepared by dissolving an adhesion promotor and/or a surfactant, or an acid in one or more solvents. In some embodiments, the surface treatment solution comprises 0.01 wt % to 5 wt % of an adhesion promoter. In some embodiments, the adhesion promoter is Lubrizol 2063, Lubrizol 2062, DowSil Z-6137, DowSil 3-6121, or PP-6. In one embodiment, the surface treatment solution comprises about 1.0 wt % Lubrizol 2063. In some embodiments, the surface treatment solution comprises 0.01 wt % to 0.5 wt % of a surfactant such as SDS. In some embodiments, the surface treatment solution comprises about 0.1 wt % SDS. In some embodiments, the surface treatment solution comprises an aqueous acid solution such as but not limited to nitric acid, sulfuric acid, hydrochloric acid, or phosphoric acid at a concentration of about 1 N. Any acid solution capable of etching the metal casing to improve adhesion may be used for the surface treatment.

The application of a primer and/or surface treatment improves the adhesion of the aversive coating to the exterior of the battery by allowing for stronger interactions between the battery casing and the aversive coating. For example, the application of a surfactant such as SDS in the primer and/or the surface treatment may help to remove grease or oil and provide a metal surface which can better adhere to the polymer of the aversive coating. In some instances, the primer and/or the surface treatment may comprise an adhesion promoter such as Lubrizol 2063, which binds to the metal surface of the battery casing. The water-soluble polymer in the aversive coating can then bind to the Lubrizol fixed on the surface of the battery casing, resulting in an aversive coating that is strongly adhered to the battery.

In some embodiments, the surface treatment to prepare the exterior of the electrochemical cell for adhesion to the aversive coating is a mechanical process to modify the surface of the metal casing. Mechanical or physical surface treatment processes include but are not limited to sandblasting, abrasion with rough material such as sandpaper, tumbling, or milling. As discussed herein, other methods for preparation of the surface of the electrochemical cell may be utilized, such as acid-based etching processes or other processes to increase the potential for adhesion to the battery surface.

In some embodiments, the primer and/or surface treatment is applied to a larger area of the electrochemical cell than the area covered by the aversive coating, but overlapping with the areas where the aversive coating is applied. For example, the entire exterior surface of the electrochemical cell may be coated in a primer or surface treatment solution, but the aversive coating may be applied only to the negative terminal. In some cases, the entire area of a terminal such as the negative terminal is coated with primer or surface treatment solution, but the aversive coating is only applied to certain portions of the negative terminal, such as the dot in an arc-shaped pattern shown in FIG. 9, or two rectangular areas across the negative terminal. For example, the aversive coating applied in dots in an arc-shaped pattern may cover about 11% of the area of the negative terminal of a coin cell with an outer diameter of 20 mm. An aversive coating applied in two rectangular areas with a length of about 12.5 mm and a width of about 2 mm may cover about 16% of the area the negative terminal of a coin cell with an outer diameter of 20 mm. In some embodiments, the primer or surface treatment is applied to greater than 40%, greater than 50%, greater than 60%, greater than 70%, greater than 80%, or greater than 90% of the total area of the exterior surface of the electrochemical cell. In some embodiments, the primer or surface treatment is applied to greater than 50%, greater than 60%, greater than 70%, greater than 80%, or greater than 90% of the total area of the positive or the negative terminal of the electrochemical cell. In some embodiments, the aversive coating is applied to 5% to 50% of the area of the positive or negative terminal.

The method also comprises preparing a coating solution by dissolving an aversive agent composition and a water-soluble polymer in one or more solvents, applying the coating solution to the prepared exterior portion of the electrochemical cell, and drying the coating solution onto the electrochemical cell.

Coating solutions comprise 0.2 wt % to 20 wt % of the aversive agent composition and 0.2 wt % to 14 wt % of the water-soluble polymer dissolved in one or more solvents. A water-soluble polymer and an aversive taste agent are dissolved in a solvent to provide a coating solution with a final concentration of 0.2 wt % to 14 wt % of the water soluble polymer and 0.2 wt % to 2 wt % of the aversive taste agent. In some embodiments, the coating solution further comprises 0.01 wt % to 3.0 wt % an adhesion promotor. In some embodiments, the coating solution further comprises 0.2 wt % to 18 wt % of a colorant. In some embodiments, the coating solution further comprises 0.01 wt % to 0.3 wt % of a surfactant. In some embodiments, the coating solution further comprises 0.01 wt % to 2.0 wt % of a viscosity modulator.

In some embodiments, the coating solution is prepared by dissolving about 12 wt % PVA, about 1.5 wt % DNB, and about 12 wt % FD&C Blue No. 1 in one or more solvents. In some embodiments, the coating solution is prepared by dissolving about 12 wt % PVA, about 1.5 wt % DNB, about 12 wt % FD&C Blue No. 1, and about 1 wt % Lubrizol 2063 in one or more solvents. In some embodiments, the coating solution is prepared by dissolving about 12 wt % PVA, about 1.5 wt % DNB, about 12 wt % FD&C Blue No. 1, about 1 wt % Lubrizol 2063, and about 0.1 wt % SDS in one or more solvents.

The water-soluble polymer may be heated to an appropriate temperature for a period of time to fully dissolve in the coating solution. In some embodiments, the water-soluble polymer is PVA and the PVA is heated to about 95° C. for about 60 minutes to dissolve. In some embodiments, a solution of dissolved adhesion promoter (e.g., Lubrizol 2063) is added to the coating solution comprising the dissolved water-soluble polymer. In some embodiments, the coating solution that was heated to dissolve the water-soluble polymer is cooled before adding the aversive agent composition comprising the aversive taste agent and optionally the colorant.

The primer solution or surface treatment solution and the aversive coating solution may be applied to the electrochemical cell using any method known in the art. In some embodiments, the primer solution or the surface treatment solution is applied by dipping, brushing or spraying the primer solution or surface treatment solution on the electrochemical cell. In some embodiments, the coating solution is applied by dipping, spraying, printing, or dispensing the coating solution on the electrochemical cell. In some embodiments, a jet dispenser is used to apply the coating solution (e.g., dots). Methods such as pad printing or screen printing may also be used to apply the coating solution. In embodiments where only a portion of the positive or negative terminal is coated with the aversive coating, a mask may be used to selectively apply the aversive coating to the desired portions of the electrochemical cell. The mask is a solid non-absorptive material with holes or gaps of a desired pattern and is placed between the electrochemical cell and apparatus dispensing the coating solution to allow the coating solution to be deposited on a specific portion of the electrochemical cell. The mask may be removed after the aversive coating has dried.

### EXAMPLES

As discussed herein, bitterants, colorants, salivating agents, and/or other aversive agents may be added to at least a portion of the exterior of a coin cell battery. Aversive agents may include substances that elicit strongly unpleasant tastes or smells such as spicy, peppery, sour, bitter, or odiferous. Examples include: denatonium benzoate (DNB), capsaicin, allyl isothiolcyanate, and piperine. For example, one or more aversive taste agents may be added in a coating that adheres to an exterior surface of the battery. In one embodiment, a water-soluble polymer such as Polyvinyl alcohol (PVA) is added to a water-based aversive agent solution so the aversive agent is encapsulated in PVA network and applied to battery surface. When the water of the aversive agent solution evaporates, the polymer acts as a binder and binds the aversive agent(s) (and other active materials, such as a colorant and/or a salivating agent to the battery surface. However, the coating remains soluble in water (or a water-like solution, such as saliva), such that the aversive agent is released from the surface of the battery when a human (e.g., a child) places the battery in his/her mouth. The unpleasant taste of the aversive agent may cause the human to spit out the battery, rather than swallowing it.

Water soluble polymers such as but not limited to PVA and polyacrylic acid (PAA) may be used as a binder for the aversive agent to the battery surface. The polymer may be a low molecular weight polymer (1-10 Ks), a medium molecular weight polymer (10-100 Ks), or a high molecular weight polymer (>100 Ks). Low molecular weight polymers have high water solubility and the shorter chains provide less chain entanglement and higher molecular mobility. However, low molecular weight polymers tend to form beads rather than fibers in solution and provide weaker materials. High molecular weight polymers have low water solubility but experience a higher degree of chain entanglement and form films with high tensile strength. Higher molecular weight polymers also tend to form tougher and more chemically resistant materials. Additionally, the viscosity of a solution containing a polymer increases with the molecular weight. Medium molecular weight polymers have intermediate water solubility, strength and viscosity. However, adhesion may be weak, particularly when manufacturing oils used in the formation of the battery can components are still present. Various methodologies may be utilized to increase the adhesion of the polymer to the battery surface.

The coating can be applied after preparing the surface of the battery (e.g., providing a primer to the surface of the battery, cleaning the surface of the battery, or pretreating the surface of the battery) using many different coating methods, such as providing small droplets of material (e.g., via a pipet). Other application methods comprise dip rinsing the battery, spraying the battery, pad printing onto the battery, screen printing onto the battery, needle dispensing onto the battery, and/or the like. Any method may be used, so long as it deposits the thin layer uniformly to provide an at least substantially uniform thickness on the surface of the battery. In certain embodiments, the coating may be applied directly to the surface of the battery and the coating may include an adhesion promoter.

The coating solution itself may have a composition of the following: a solvent (comprising, for example, water, iosproanol, ethanol, mixtures thereof, and/or other organic solvent materials); DNB (or other aversive agents), optional additives (e.g., surfactants, adhesion promotors, etc.), optional low concentrations of polymeric binders (e.g., PVA, PAA, polyethylene glycol, polyacrylamides, and/or the like), optional viscosity modifiers for better processing (e.g., Carboxymethylcellulose (CMC)). In certain embodiments, the coating may additionally comprise an adhesion promoter (e.g., DowSil Z-6137, DowSil 3-6121, Lubrizol-2062, Lubrizol 2063H, PP-6, and/or the like). The coating may be applied via a spray.

The quantity of aversive taste agent may be selected to provide an unappealing taste of the battery. For example, an amount of DNB may be selected to be between 4-120 μg (e.g., between 5-30 μg) for each coin cell. Aversive agents may include substances that elicit strongly unpleasant tastes or smells such as spicy, peppery, sour, bitter, or odiferous. Example aversive taste agents include: capsaicin, allyl isothiocyanate, and piperine.

The coating can be applied using many different coating methods, such as providing small droplets of material (e.g., via a pipet). Other application methods comprise dip rinsing the battery, spraying the battery, pad printing onto the battery, screen printing onto the battery, needle dispensing onto the battery, and/or the like. Any method may be used, so long as it deposits the thin layer uniformly.

In certain embodiments, additional additives may be provided to further increase desired characteristics of the resulting coating. For example, a surfactant can be added to the solution to increase the wettability of the coating. In certain embodiments, the battery surface can also be treated by plasma ultra-sonic or other means to increase surface energy to better accept the coating.

When coating a terminal (e.g., the negative terminal), a portion of the terminal may be masked (e.g., the outermost 1-2 mm to prevent shorting when wetted with the solution) so that the masked portion is not coated with the coating material. The coating material may then be sprayed onto the terminal, and then the mask may be removed after the coating has dried.

Prior to coating, the battery may be cleaned or otherwise prepared to remove manufacturing oil residues on the surface of the battery. For example, the battery may be rinsed in deionized water (e.g., cyclically treated dionized water having a conductivity σ<10 uS/cm) for a total of 8 seconds at 30° C. The battery may be hot air dried beginning 0.5 seconds after the rinse is completed. The hot air dry has a duration of approximately 3 seconds at an air temperature of 25° C.

The coating may be sprayed onto the cleaned battery surface, approximately 1 second after air drying is complete. The battery may then be dried (e.g., via hot air drying) to dry the coating onto the cell. If a portion of the cell was masked, the mask may be removed after drying the coating.

By spraying the coating material onto specific portions of the cell, the conductivity of the cell may be maintained even when the thickness of the coating impedes electron transfer therethrough. Said differently, the coating need not be sufficiently thin to maintain conductivity if the coating is placed onto portions of the cell where conductivity is not critical. The total loading of aversive agent (e.g., bitterant) may be increased on the battery when providing a thick coating layer on portions of the battery, while maintaining other uncoated portions of the battery.

As examples, the coatings may be provided on the positive terminal and/or the negative terminal of the battery. The coatings may be provided over a portion of the positive terminal and/or the negative terminal, leaving the remainder of the terminal exposed.

### Conclusion

Many modifications and other embodiments of the embodiments set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the present application. Generally the term “about”, as used herein when referring to a measurable value such as an amount of weight, time, dose, etc. is meant to encompass in one example variations of ±20%, in another example ±10%, in another example ±5%, in another example ±1%, and in yet another example ±0.1% from the specified amount, as such variations are appropriate to perform the disclosed method.

All examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features and steps are not limited to serial execution, but rather may be executed asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations that are disclosed and may not explicitly recited. As such, it should be understood that advantages, embodiments, examples, functional, features, logical, operational, organizational, structural, topological, and/or other aspects of the disclosure are not to be considered limitations on the disclosure as defined by the embodiments, examples, claims or limitations on equivalents to the embodiments, examples, and/or claims. It is to be understood that, depending on the particular needs and/or characteristics of an electrochemical cell, such as a coin cell battery or the like, various embodiments or portions of various embodiments of the coin cell batteries described herein may be implemented that allow a great deal of flexibility and customization.

1. An electrochemical cell comprising:
a positive terminal defining a first portion of an exterior of the electrochemical cell;
a negative terminal that is electrically insulated from the positive terminal and defining a second portion of the exterior of the electrochemical cell;
wherein at least the part of the exterior of the electrochemical cell is prepared for adhesion with an aversive coating by performing a mechanical process or applying a composition to the exterior of the electrochemical cell to form a prepared exterior portion;
an anode positioned within an interior of the electrochemical cell and in electrical connection with the negative terminal;
a cathode positioned within the interior of the electrochemical cell, wherein the cathode is electrically separated from the anode and is in electrical connection with the positive terminal; and
an aversive coating covering at least a part of the prepared exterior portion, wherein the aversive coating comprises:
an aversive agent composition; and
a water-soluble polymer.

2. The electrochemical cell of claim 1, wherein the aversive agent composition comprises at least one aversive taste agent selected from: denatonium benzoate (DNB), capsaicin, allyl isothiocyanate, or piperine.

3. The electrochemical cell of claim 1, wherein the water-soluble polymer is selected from the group consisting of polyvinyl alcohol (PVA), polyacrylic acid (PAA), polyacrylamide, and polyethylene glycol (PEG).

4. The electrochemical cell of claim 1, wherein the water-soluble polymer is PVA and the PVA is has a molecular weight of about 75,000 and is about 88% hydrolyzed.

5. The electrochemical cell of claim 1, wherein the aversive agent composition further comprises a colorant.

6-7. (canceled)

8. The electrochemical cell of claim 1, wherein the composition applied to the exterior of the electrochemical cell is a primer, wherein the primer has a dry-weight composition comprising at least 50 wt % of a water-soluble polymer.

9. The electrochemical cell of claim 8, wherein the water-soluble polymer of the primer is PVA or PAA.

10. The electrochemical cell of claim 1, wherein the composition applied to the exterior of the electrochemical cell is a surface treatment composition.

11. The electrochemical cell of claim 10, wherein the surface treatment composition comprises an acid.

12. The electrochemical cell of claim 1, wherein the composition applied to the exterior of the electrochemical cell comprises an adhesion promoter.

13. The electrochemical cell of claim 12, wherein the adhesion promoter is Lubrizol 2063, Lubrizol 2062, DowSil Z-6137, DowSil 3-6121, or PP-6.

14. (canceled)

15. The electrochemical cell of claim 1, wherein the composition applied to the exterior of the electrochemical cell comprises a surfactant.

16. The electrochemical cell of claim 15, wherein the surfactant is sodium dodecyl sulfate (SDS).

17. The electrochemical cell of claim 8, wherein the primer further comprises up to 10 wt % of the aversive taste agent.

18. The electrochemical cell of claim 8, wherein the primer has a thickness of less than 1 μm.

19. The electrochemical cell of claim 1, wherein the exterior of the electrochemical cell is prepared for adhesion by sandblasting, abrasion with sandpaper, tumbling, or milling.

20. The electrochemical cell of claim 1, wherein the electrochemical cell is a button cell or a coin cell.

21-22. (canceled)

23. The electrochemical cell of claim 1, wherein the electrochemical cell is packaged in child-resistant packaging.

24. A method of preparing an electrochemical cell, wherein at least a part of the exterior of the electrochemical cell is prepared for adhesion with an aversive coating by applying a primer, wherein the aversive coating comprises an aversive agent composition and a water-soluble polymer, the method comprising:
preparing a primer solution, wherein the primer solution comprises 0.1 wt % to 0.5 wt % of the water-soluble polymer dissolved in one or more solvents;
applying the primer solution to at least part of the exterior of the electrochemical cell;
drying the primer solution onto the exterior of the electrochemical cell to form a prepared exterior portion;
preparing a coating solution, wherein the coating solution comprises the aversive agent composition and the water-soluble polymer;
applying the coating solution to the prepared exterior portion of the electrochemical cell; and
drying the coating solution onto the prepared exterior portion of the electrochemical cell.

25-32. (canceled)

33. A method of preparing an electrochemical cell, wherein at least a part of the exterior of the electrochemical cell is prepared for adhesion with an aversive coating by applying a surface treatment composition, wherein the aversive coating comprises an aversive agent composition and a water-soluble polymer, the method comprising:
preparing a surface treatment solution, wherein the surface treatment solution comprises an adhesion promoter, a surfactant, or an acid dissolved in one or more solvents;
applying the surface treatment solution to at least part of the exterior of the electrochemical cell;
drying the surface treatment solution onto the exterior of the electrochemical cell to form a prepared exterior portion;
preparing a coating solution, wherein the coating solution comprises the aversive agent composition and the water-soluble polymer;
applying the coating solution to the prepared exterior portion of the electrochemical cell; and
drying the coating solution onto the prepared exterior portion of the electrochemical cell.

34-42. (canceled)
